(19) United States
(12) Patent Application Publication
(10) Pub. No.: US 2006/0276157 A1
(43) Pub. Date: Dec. 7, 2006

(54) Apparatus and methods for packaging antennas with integrated circuit chips for millimeter wave applications

(76) Inventors: Zhi Ning Chen, Singapore (SG); Duixian Liu, Scarsdale, NY (US); Ullrich R. Pfeiffer, Yorktown Heights, NY (US); Thomas M. Zwick, Kisslegg (DE)

Correspondence Address: F. CHAU & ASSOCIATES, LLC, 130 WOODBURY ROAD, WOODBURY, NY, 11797, US

(21) Appl. No.: 11/144,504

(22) Filed: Jun. 3, 2005

(51) Int. Cl. H04B 1/28

(52) U.S. Cl. 455/333

(57) ABSTRACT

Apparatus and methods are provided for integrally packaging semiconductor IC (integrated circuit) chips and antenna devices which are integrally constructed from package frame structures (e.g., lead frame, package carrier, package core, etc.), to thereby form compact integrated radio/wireless communications systems for millimeter wave applications.

### TECHNICAL FIELD OF THE INVENTION

The present invention generally relates to apparatus and methods for integrally packaging antenna devices with semiconductor IC (integrated circuit) chips and, in particular, apparatus and methods for packaging IC chips with antenna devices that are integrally constructed from package frame structures, to thereby form compact integrated radio/wireless communications systems for millimeter wave applications.

### BACKGROUND

To enable wireless communication between devices in network systems such as wireless PAN (personal area network), wireless LAN (local area network), wireless WAN (wide area network), cellular network systems, and other types of radio systems, the devices are equipped with receivers, transmitters, or transceivers, as well as antennas that can efficiently radiate/receive signals transmitted to/from other devices in the communication network.

With conventional radio communication systems, discrete components are individually encapsulated or individually mounted with low integration levels on printed circuit boards, packages or substrates. For example, for millimeter-wave applications, radio communication systems are typically built using expensive and bulky wave guides and/or package-level or board-level microstrip structures to provide electrical connections between semiconductor chips (RF integrated circuits) and between semiconductor chips and transmitter or receiver antennas.

### SUMMARY OF THE INVENTION

In view of recent innovations in semiconductor fabrication and packaging technologies, the dimensions of radio communication systems are becoming increasing smaller and consequently, the integration of antennas with RF integrated circuits is becoming practically feasible. In this regard, exemplary embodiments of the invention are provided for integrally packaging antennas with semiconductor IC (integrated circuit) chips to provide small, compact electronic devices with highly integrated radio/wireless communications systems for millimeter wave applications. In particular, exemplary embodiments of the invention include apparatus and methods for integrally packaging IC chips together with antenna devices in compact package structures, wherein the antennas are integrally constructed are part of the package frame structures.

For example, in one exemplary embodiment of the invention, an electronic apparatus includes a package frame having an antenna that is integrally formed as part of the package frame and an IC (integrated circuit) chip mounted to the package frame. The apparatus further comprises interconnects that provide electrical connections to the IC chip and the antenna, and a package cover.

In various exemplary embodiments of the invention, the package frame may be a package lead frame (leadless or leaded), a package substrate, a package carrier, a package core, etc., which can be fabricated using known semiconductor fabrication methods to include antenna elements integrally formed as part of the package frame structure.

In one exemplary embodiment, the package cover can fully encapsulates the IC chip and package frame, or in another embodiment, the package cover can be formed to expose a portion or region of the package frame which contains the integrally formed antenna.

In other exemplary embodiments of the invention, one or more IC chips can be mounted to the package frame using flip-chip or backside mounting methods, wherein suitable electrical connections such as wire bonds, printed transmission lines, solder ball connections, etc., can be used to form the electrical connections to the IC chip(s) and antenna and between the IC chip(s) and antenna.

In yet other exemplary embodiments of the invention, transmission lines, antenna feed networks and/or impedance matching networks can be integrally formed as part of the package frame, for providing electrical connections to one or more antennas that are formed as part of the package frame.

In other exemplary embodiments of the invention, antennas can be packaged with IC chips that comprise integrated radio receiver circuits, integrated radio transmitter circuits, integrated radio transceiver circuits, and/or other supporting radio communication circuitry.

In yet other exemplary embodiments of the invention, various types of antennas may be implemented, including folded dipole antennas, dipole antennas, patch antennas, loop antennas, etc. For grounded antennas, ground planes can be formed as part of the chip package, or formed on a PCB or PWB to which the chip package is mounted.

These and other exemplary embodiments, aspects, features and advantages of the present invention will be described or become apparent from the following detailed description of exemplary embodiments, which is to be read in connection with the accompanying drawings.

### BRIEF DESCRIPTION OF THE DRAWINGS

FIG. 1 is a schematic diagram illustrating an apparatus for integrally packaging an antenna and IC chip, according to an exemplary embodiment of the present invention.

FIG. 2 is a schematic diagram illustrating an apparatus for integrally packaging an antenna and IC chip, according to another exemplary embodiment of the present invention.

FIG. 3 is a schematic diagram illustrating an apparatus for integrally packaging an antenna and IC chip, according to another exemplary embodiment of the present invention.

FIGS. 4A, 4B, 5A, 5B, 6A, 6B, 7A, and 7B are schematic diagrams illustrating a method for packaging an antenna and IC chip according to an exemplary embodiment of the invention, wherein:

FIG. 4A is a schematic top plan view of an exemplary lead frame structure which is patterned to form antenna radiating elements and FIG. 4B is a schematic side view of FIG. 4A along line 4B-4B;

FIG. 5A is a schematic top plan view of the exemplary lead frame structure of FIG. 4A after mounting an IC chip and forming bond wires, and FIG. 5B is a schematic side view of FIG. 5A along line 5B-5B;

FIG. 6A is a schematic top plan view of the exemplary structure of FIG. 5A after an forming an encapsulation layer, and FIG. 6B is a schematic side view of FIG. 6A along line 6B-6B; and wherein

FIG. 7A is a schematic top plan view of an exemplary package structure which results from dicing the exemplary structure of FIG. 6A along lines x1, x2, y1 and y2 in FIG. 6A, and FIG. 7B is a schematic side view of FIG. 7A along line 7B-7B.

FIG. 8 is a schematic diagram illustrating the exemplary package structure depicted in FIGS. 7A˜7B mounted on a PCB (printed circuit board) or PWB (printed wiring board), according to an exemplary embodiment of the invention.

FIG. 9 depicts exemplary dimensions of the PCB mounted package structure of FIG. 8, according to an exemplary embodiment of the invention.

FIG. 10 depicts an exemplary folded dipole antenna which can be constructed and packaged using methods according to exemplary embodiments of the invention.

### DETAILED DESCRIPTION OF EXEMPLARY EMBODIMENTS

Exemplary embodiments of the invention as described in detail hereafter generally include apparatus and methods for integrally packaging antenna devices and semiconductor IC chips to form electronic devices having highly-integrated, compact radio/wireless communications systems for millimeter wave applications. More specifically, exemplary embodiments of the invention include apparatus and methods for integrally packaging IC chips with antenna devices having radiating elements that are integrally constructed from one of various types of package frame structures that are commonly used for constructing chip packages. In general, package frames are those structures commonly used for constructing chip packages, which function to, e.g., provide mechanical stability to the chip package, provide chip bond sites for mechanically mounting one or more IC chips (or dies), and provide electrical lines and/or contacts that are used for making electrical connections to the IC chip(s) mounted thereto. In this regard, the term “package frame” or “package frame structure” as used herein should be broadly construed to include a broad range of various types of package structures including, but not limited to, package cores, substrates, carriers, die paddles, lead frames, etc., and other package structures that provide functions such as listed above (e.g., mechanical stability, chip mounting, electrical interface).

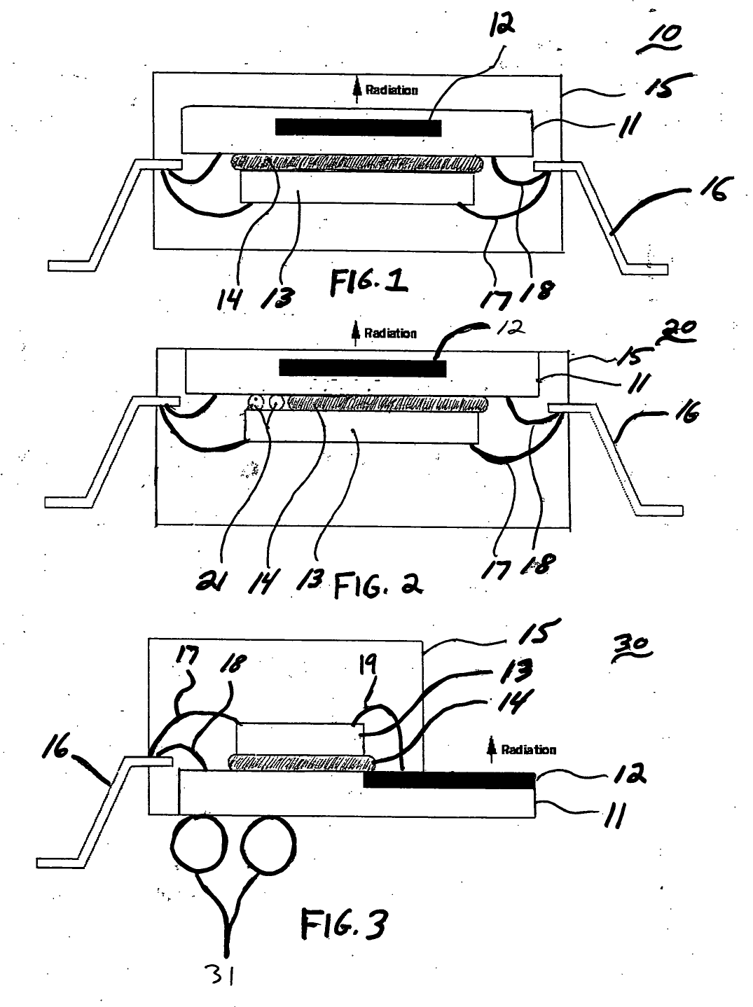

FIGS. 1, 2 and 3 schematically illustrate compact package structures according to exemplary embodiments of the invention, for integrally packaging IC chips with antenna devices to construct RF or wireless communications chips. Indeed, by way of example, antennas according to the invention which are designed to operate at resonant frequencies of about 20 GHz or greater are sufficiently small to be packaged with IC chips in compact package structures similar in size to that of existing leaded carriers or leadless chip carriers.

In particular, FIG. 1 schematically depicts an electronic apparatus (10) for integrally packaging an antenna and IC chip, according to an exemplary embodiment of the present invention. The apparatus (10) comprises a package frame structure (11) having one or more antenna elements (12) (e.g., radiating elements, ground plane) integrally constructed from the package frame (11). Depending on the packaging technology implemented and intended application, as noted above, the package frame structure (11) may be any one of common structures, including, but not limited, laminate substrates (FR-4, FR-5, BTTM and others), buildup substrates (thin organic buildup layers or thin film dielectrics on a laminate or copper core), ceramic substrates (alumina), HiTCETM ceramic, glass substrates with BCBTM dielectric layers, lead-frame structures, semiconductor carriers, die-paddles, etc., which can be fabricated to include one or more antenna elements (12) to form an antenna.

The apparatus (10) further comprises an IC chip (13) (or die) that is backside mounted to the bottom surface of the package frame structure (11) using bonding material (14) (e.g., solder, epoxy, etc.). The apparatus (10) comprises other structures that are typically used for packaging IC chips such as package encapsulation (15) (or cover, lid, seal, passivation, etc.) to provide protection/insulation from the environment, package terminals (16) and wire bonds (17) and (18) for making electrical connections from bond pads on the chip (13) and/or package frame (11) to appropriate package terminals (16). FIG. 1 depicts an exemplary package structure with a fully encapsulated antenna, wherein radiation from the antenna device (12) is emitted from the top of the apparatus (10).

FIG. 2 schematically depicts an apparatus (20) for integrally packaging an antenna and IC chip according to another exemplary embodiment of the present invention. The electronic apparatus (20) is similar to the electronic apparatus (10) of FIG. 1, except that the package encapsulation (15) is formed such that the top surface of the package frame structure (11) having the integrated antenna (12) is exposed to enable more efficient radiation. In addition, the apparatus (20) comprises solder ball connectors (21) that provide direct electrical connections between the package frame structure (11) and the chip (13).

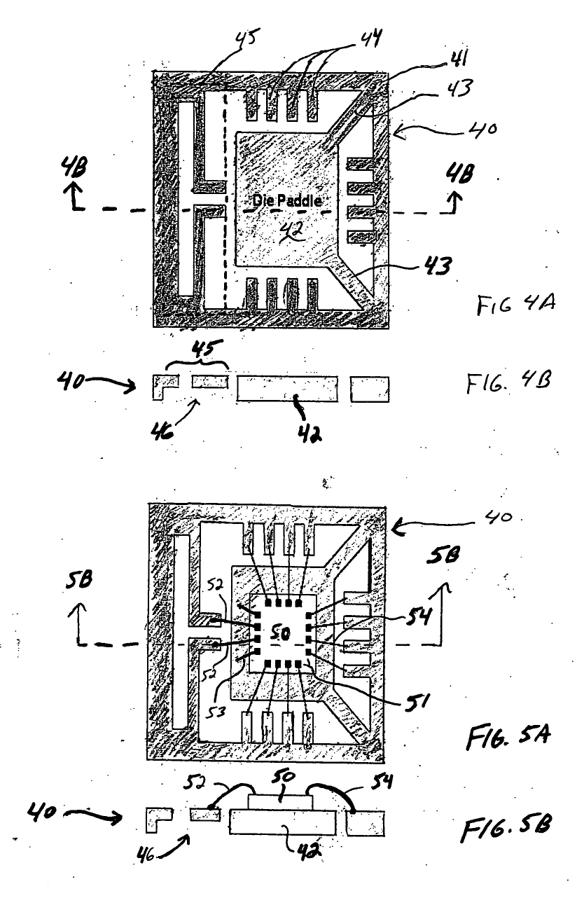

FIG. 3 schematically depicts an apparatus (30) for integrally packaging an antenna and IC chip according to yet another exemplary embodiment of the present invention. The apparatus (30) is designed such that the die (13) is mounted to the top surface of the package frame structure (11) such that a portion of the package frame structure (11) protrudes from the package encapsulation (15) to expose radiating elements of the antenna (12). Moreover, in one exemplary embodiment, depending on the packaging technology implemented, the apparatus (30) may comprise solder balls (31) to enable flip-chip bonding to a PCB or another substrate carrier structure, etc. (as opposed to using lead elements (16)). In addition, bond wires (19) can be formed to make electrical connections between the die (13) and the antenna elements (12).

It is to be understood that the exemplary electronic apparatus depicted in FIGS. 1-3 can be constructed using various types of chip packaging and PCB mounting technologies, and that the invention is not limited to any specific chip packaging and mounting technologies. For example, in one exemplary embodiment of the invention, lead frame packaging methods can be implemented for packaging IC chips with antennas that are integrally formed as part of a package lead frame.

By way of specific example, state-of-the-art, low-cost packaging technologies typically use a “non-leaded” frame structure to allow the overall package body to be made very compact in size. Leadless packages, such as QFN (Quad Flat No-Lead) packages, are packages that are characterized by the provision of non-protruding leads (or pads) on the bottom of the encapsulation body for providing external electrical connections. Since the leads are non-protruding, the package body appears to be “non-leaded” and thus reduces the overall package size. A QFN package is mounted on a printed circuit board (PCB) using SMT (Surface Mount Technology), wherein the package is electrically connected to the PCB by soldering the non-protruding pads on the bottom side of the package body to appropriate bond pads on the surface of the PCB.

For purposes of illustration, exemplary methods according to the invention for packaging IC chips with antennas integrally formed as part of a package lead frame will now be discussed with reference to FIGS. 4-7. In particular, FIGS. 4-7 depict a method for integrally packaging an IC chip and antenna using a leadless packaging method (e.g., QFN) according to an exemplary embodiment of the invention, wherein radiating elements of a dipole antenna are integrally formed as part of a lead frame structure (package frame) of a leadless package.

An initial step of the exemplary packaging method, as depicted in FIGS. 4A and 4B, includes constructing a lead frame structure by patterning a metallic substrate to include one or more antenna radiating elements. In particular, FIG. 4A is a schematic plan view of a lead frame structure (40) according to an exemplary embodiment of the invention and FIG. 4B is a schematic cross-sectional view of the exemplary lead frame structure (40) as viewed along line 4B-4B in FIG. 4A. In FIGS. 4A and 4B, the exemplary lead frame (40) is used as a package frame of a leadless package for mounting an IC chip and forming an antenna. The lead frame (40) comprises a peripheral frame portion (41), a die paddle (42), die paddle support bars (43), a plurality of lead elements (44), and an antenna region (45) (denoted by dotted lines) in which radiating elements are formed. In the exemplary embodiment, the antenna region (45) comprises a folded dipole antenna pattern, although other antenna designs may be implemented.

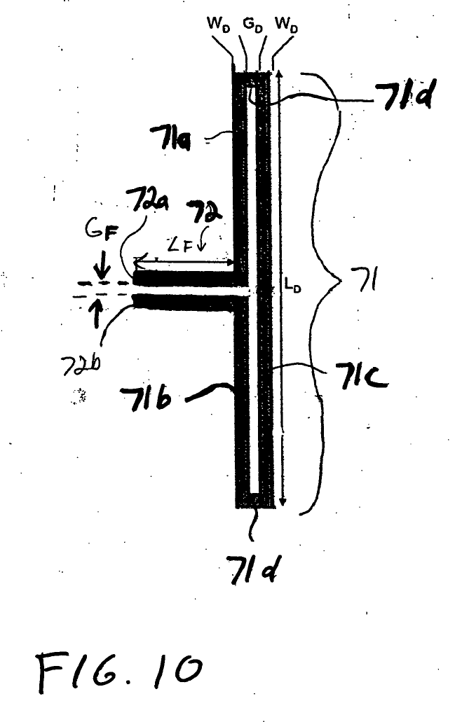

The lead-frame (40) can be fabricated using known techniques. For example, the lead-frame (40) can be constructed from a thin metallic sheet or metallic plate that is formed of metallic material such as, e.g., copper (Cu), a Cu-based alloy or other suitable conductor materials, having a thickness of about 1,000 microns, for example. The exemplary lead frame (40) pattern can be formed by etching, stamping or punching the metallic plate using known methods. In addition, the lower metallic surfaces of the metallic plate in antenna region (45) are subjected to a half-etching process, whereby the bottom surface of the antenna metallization in region (45) is etched to form a recess region (46) (or cavity region). The half-etching can be performed, for example, by placing an etch mask on the bottom surface of the lead frame (40) which exposes the metal surfaces in region (45), and applying etching material (e.g. chemical wet etch) to etch the metal and form the recess (46). In one exemplary embodiment, the recess region (46) is formed to a depth of about 500 microns. As explained below, the recess region (46) provides a well defined cavity or gap between the antenna radiating element(s) and a ground plane that is disposed on a PCB or PWB to which the integrated chip package is mounted (as will be explained below with reference to FIGS. 8 and 9, for example).

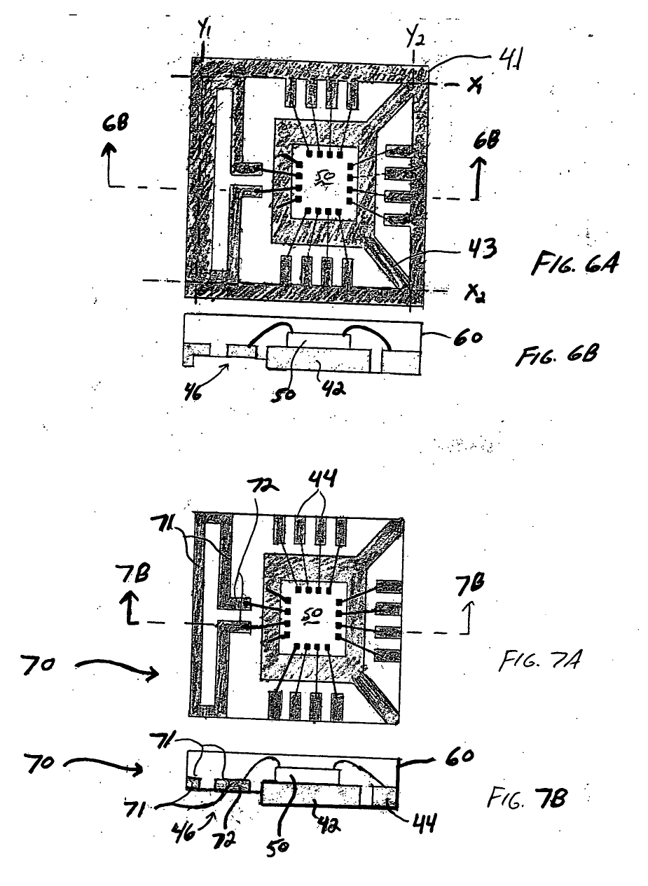

After the lead frame (40) is constructed, the exemplary packaging method proceeds with a chip mounting process and wire bonding process to mount a chip to the lead frame (40) and make appropriate electrical connections between the mounted chip and lead frame elements. More specifically, FIG. 5A is a schematic plan view illustrating the lead frame (40) having an IC chip (50) mounted on the die paddle (42), and FIG. 5B is a schematic cross-sectional view of FIG. 5A as viewed along line 5B-5B in FIG. 5A. In FIGS. 5A and 5B, the IC chip (50) is depicted as having a plurality of contact pads (51) disposed around the peripheral region of the front (active) surface of the IC chip (50), and being backside mounted to the die-paddle (42).

The IC chip (50) can be bonded to the die paddle (42) using any suitable bonding material placed between the bottom (non active) surface of the chip (50) and the surface of the die-paddle (42). Thereafter, electrical connections can be made by forming various bond wires including, e.g., bond wires (52) that make connections from the IC chip (50) to the differential inputs lines of the exemplary dipole antenna, a plurality of grounding bond wires (53) that form ground connections to the die paddle (42), and a plurality of bond wires (54) that connect to appropriate lead frame elements (44). It is to be appreciated that wire bonding methods of FIGS. 5A and 5B are merely exemplary, and that other methods such as flip-chip bonding methods could be used to connect the die to the package leads and the antenna feeds, depending on the packaging method and package frame structure implemented.

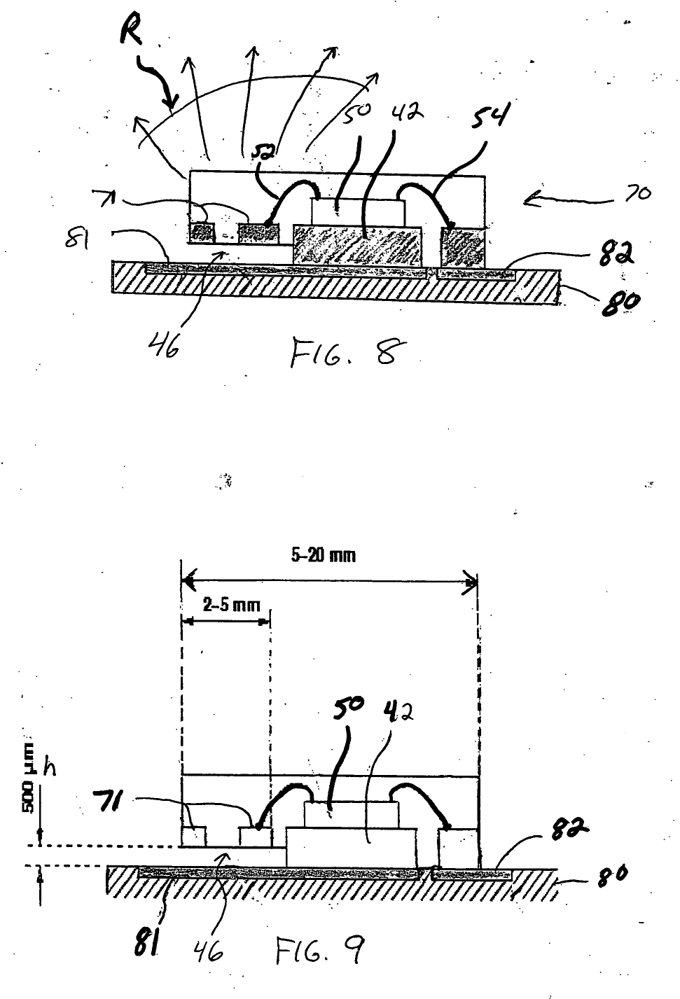

A next step in the exemplary packaging method includes forming a package encapsulation to seal the IC chip (50), bond wires, etc., such as depicted in the exemplary schematic diagrams of FIGS. 6A and 6B. More specifically, FIG. 6A is a schematic plan view of the structure of FIG. 5A with a package encapsulation (60) (not specifically shown) formed over the lead frame (40) elements, IC chip (50) and bonding wires, and FIG. 6B is a schematic cross-sectional view of FIG. 6A as viewed along line 6B-6B in FIG. 6A. The package encapsulation (60) may comprise plastic packaging materials such as resin materials, and particularly, epoxy based resin materials.

In one exemplary embodiment of the invention as depicted in FIG. 6B, the encapsulation process is performed such that the recess region (46) below the antenna region (45) is not filled with the encapsulation material. This could be performed by using a filler material or plunger that is temporary disposed in the cavity (46) during the encapsulation process, for example. In other exemplary embodiments of the invention, the recess region (46) can be filled with encapsulation material, if the dielectric constant and/or electrical properties of the encapsulation material are suitable for the intended antenna design and performance.

After forming the encapsulation layer (60), the resulting structure is subjected to a dicing process along a perimeter of the package structure to remove the surrounding metal that holds together the antenna, leads and die-paddle. For instance, FIG. 7A is a schematic plan view illustrating an exemplary package structure (70) that is obtained after dicing the exemplary structure of FIG. 6A along lines x1, x2, y1 and y2, and FIG. 7B is a schematic cross-sectional view of the package structure (70) of FIG. 7A as viewed along line 7B-7B. As depicted in FIG. 7A, the dicing process results in removing the supporting frame portion (41) of the lead frame (40) to thereby isolate the antenna elements (71), leads (44) and die paddle (42), which are supported by the encapsulation (60) (mold material). It is to be appreciated that the encapsulant (60) need not cover the entire antenna structure (71) as long as the feed (72) can provide enough support and protection for the antenna (71) and its electrical connection.

FIG. 8 is schematically illustrates the exemplary package structure (70) mounted on a PCB (80). FIG. 8 illustrates the PCB (80) having a plurality of bonding pads (81) and (82) that enable the leadless package (70) to be surface mounted to the PCB (80). The bond pads include a ground pad (81) to which the die paddle (42) is bonded, and other bond pads (82) to provide electrical connections to wires and other components on the PCB (80). In an exemplary embodiment, the ground pad (81) is dimensioned and arranged such that it is disposed below the antenna (71) and feed (72). The planar metallic ground plane (81) is disposed substantially parallel to the antenna (71). The ground plane (81) is positioned at a distance (h) from the bottom surface of the antenna (71) thereby forming the space (46) (or cavity) between the ground plane (81) and printed antenna (71). In one exemplary embodiment, the space/cavity (46) can be filled with air (dielectric constant=1). In another exemplary embodiment, the space/cavity (46) can be filled with a foam material having a relatively low dielectric constant close to that of air (e.g., dielectric constant=1.1), which adds additional mechanical support. For antennas that require a ground plane, the ground plane (81) of the PCB (80) can act as a ground plane for the antenna (71). For groundless antenna types, the ground plane can be used to provide a desired radiation pattern, such as a hemispherical radiation pattern as depicted in the exemplary embodiment of FIG. 8.

FIG. 9 depicts exemplary dimensions of the PCB mounted package structure of FIG. 8 for MMW applications, according to an exemplary embodiment of the invention for MMW applications. For instance, depending on the application, packaging method and chip size, the overall package (70) may have a width of between 5-20 mm, with the antenna region having an available width of 2-5 mm. Moreover, in the exemplary embodiment, the antenna (71) is displaced from the ground plane (81) of the PCB (80) by approximately 500 microns.

FIG. 10 depicts exemplary dimensions of the folded dipole antenna (71) and differential feed line (72) for the package structure of FIG. 7A. In FIG. 10, the folded dipole antenna (71) comprises a first (fed) half-wavelength dipole element comprising first and second quarter-wave elements (71a) and (71b) and a second half-wavelength dipole element (71c), which are disposed parallel to each other and separated by a gap, G_{D}. The end portions of elements (71a) and (71b) are connected (shorted) to end portions of the second dipole element (71c) by elements (71d).

Moreover, the differential feed line (72) comprises two coplanar parallel feed lines (72a, 72b) of length, L_{F}, that are separated by a gap, G_{F}. The gap G_{F} between the feed lines (72a, 72b) results in the formation of a balanced, edge-coupled stripline transmission line. The gap G_{F} of the differential line (72) separates the first half-wavelength dipole element into the first and second quarter-wavelength elements (71a) and (71b). The impedance of the differential line (72) can be adjusted by, e.g., varying the width of the feed lines (72a, 72b) and the size of the gap G_{F} between the feed lines (72a, 72b) as is understood by those of ordinary skill in the art.

The folded dipole antenna (71) has a length, denoted as L_{D}, and a width denoted as W_{D}. The parameter L_{D} of the folded dipole antenna (71) will vary depending on the frequency of operation and the dielectric constant of the surrounding material, for example. By way of example, to provide a resonant frequency in a range of about 60 GHZ-61.5 GHz, the folded dipole antenna (71) can have dimensions of about W_{D}=40 microns, G_{D}=40 microns and L_{D}=1460 microns.

It is to be understood that the chip packaging apparatus and methods discussed above are merely exemplary embodiments, and that one of ordinary skill in the art can readily envision other electronic devices that can be constructed based on the teachings herein. For instance, depending on the intended application and/or frequency of operation, various types of antennas can be integrally formed from package frame structures, including, but not limited to, dipole antennas, ring antennas, rectangular loop antennas, patch antennas, coplanar patch antennas, monopole antennas, etc. By way of example, all or a portion of the die paddle (42) depicted in FIG. 4A, for example, may comprise a patch antenna, where the IC chip (50) is mounted to the die paddle with an insulating bonding material.

Furthermore, various types of IC chips may be integrally packaged with one or more antennas to construct electronic devices having highly-integrated, compact radio communications systems. For instance, an IC chip comprising an integrated transceiver circuit, an integrated receiver circuit, an integrated transmitter circuit, and/or other support circuitry, etc., can be packaged with one or more antennas integrally formed as part of the package frame to provide compact radio communications chips. These radio communications chips can be installed in various types of devices for wireless communication applications.

In other exemplary embodiments, a radio communications chip may be constructed with a package frame structure that comprises a plurality of integrated antennas. For example, an electronic radio communications chip can be constructed having IC receiver and transmitter chips and separate antennas—a receiving antenna and transmitting antenna—for each IC chip, which are formed as part of the package frame structure to which the chips are mounted.

In other exemplary embodiments, various types of antenna feed networks and/or impedance matching networks, such as balanced differential lines, coplanar lines, etc., can be integrally formed on the IC chips and/or package frame structures. For example, an impedance matching network (e.g., a transmission line) may be integrally formed on an IC chip or package frame structure to provide the necessary inductive/capacitive impedance matching between a device/component (e.g., power amplifier, LNA, etc.) formed on the IC chip and an antenna that is integrally formed from a package frame structure. Moreover, various types of feed networks may be implemented depending on, e.g., the impedance that is desired for the given application and/or the type of devices to which the antenna may be connected. For example, if the antenna is connected to an integrated transmitter system, the feed network will be designed to provide the proper connections and impedance matching for, e.g., a power amplifier. By way of further example, if the antenna is connected to a receiver system, the feed network may be designed to provide the proper connections and impedance matching for, e.g., an LNA (low noise amplifier).

Those of ordinary skill in the art will readily appreciate various advantages afforded by the present invention. For instance, package frame structures with integrated antennas according to exemplary embodiments of the invention can be constructed using known semiconductor fabrication and packaging techniques, thereby providing high-volume, low cost, antenna manufacturing capability. Moreover, exemplary embodiments of the invention enable formation of highly-integrated, compact radio communications systems in which antennas are integrally formed as part of a package frame structure and packaged with IC chips, thereby providing compact designs with very low loss between the transceiver and the antenna. Moreover, the use of integrated antenna/IC chip packages according to the present invention saves significant space, size, cost and weight, which is a premium for virtually any commercial or military application.

Although exemplary embodiments have been described herein with reference to the accompanying drawings for purposes of illustration, it is to be understood that the present invention is not limited to those precise embodiments, and that various other changes and modifications may be affected herein by one skilled in the art without departing from the scope of the invention.

We claim:

1. An electronic apparatus, comprising:
a package frame comprising an antenna that is integrally formed as part of the package frame;
an IC (integrated circuit) chip mounted to the package frame;
interconnects that provide electrical connections to the IC chip and the antenna; and
a package cover.

2. The apparatus of claim 1, wherein the package frame comprises a package lead frame.

3. The apparatus of claim 1, wherein the package frame comprises a package substrate.

4. The apparatus of claim 1, wherein the package frame comprises a package carrier.

5. The apparatus of claim 1, wherein the package frame comprises a package core.

6. The apparatus of claim 1, wherein the package cover fully encapsulates the IC chip and package frame.

7. The apparatus of claim 1, wherein the package frame comprises an antenna region on a first side of the package frame where radiation is emitted from or coupled to the antenna.

8. The apparatus of claim 7, wherein the package cover is formed to expose the first side of the package frame.

9. The apparatus of claim 7, wherein the package cover is formed to expose at least the antenna region on the first side of the package frame.

10. The apparatus of claim 7, wherein the IC chip is mounted to a second side of the package frame opposite the first side of the package frame.

11. The apparatus of claim 7, wherein the IC chip is mounted to the first side of the package frame in a region that is adjacent the antenna region.

12. The apparatus of claim 1, wherein the package frame further comprises an integrally formed antenna feed network.

13. The apparatus of claim 1, wherein the package frame further comprises an integrally formed impedance matching network.

14. The apparatus of claim 1, wherein the interconnects comprise bond wires that connect bond pads on the IC chip to an antenna feed network.

15. The apparatus of claim 1, wherein the interconnects comprise transmission lines that are integrally formed as part of the package frame.

16. The apparatus of claim 1, wherein the interconnects comprise solder ball connections between the package frame and the IC chip that is flip-chip mounted to the package frame.

17. The apparatus of claim 1, wherein the IC chip comprises an integrated radio receiver circuit.

18. The apparatus of claim 1, wherein the IC chip comprise an integrated radio transmitter circuit.

19. The apparatus of claim 1, wherein the IC chip comprises an integrated radio transceiver circuit.

20. The apparatus of claim 1, wherein the antenna has a resonant frequency of about 20 GHz or greater.

21. The apparatus of claim 1, wherein the antenna is a folded dipole antenna or a dipole antenna.

22. An electronic apparatus, comprising:
a metallic lead frame that is patterned to form one or more antenna elements as part of the package lead frame;
an IC (integrated circuit) chip mounted to a die paddle of the package lead frame;
interconnects that provide electrical connections to the IC chip and the antenna; and
a package cover.

23. The apparatus of claim 22, wherein the metallic lead frame is a non-leaded frame.

24. The apparatus of claim 22, wherein the metallic lead frame has a recess region on one side thereof in which the one or more antenna elements are formed.

25. The apparatus of claim 24, wherein the recess region is filled with a material forming the package cover.

26. The apparatus of claim 24, wherein the recess region comprises an air cavity.

27. The apparatus of claim 22, wherein at least a portion of the die paddle comprises a radiating element of the antenna.

28. A method for constructing a chip package, comprising:
forming a package frame having an integrally formed antenna;
mounting an IC (integrated circuit) chip to the package frame; and
forming a package cover.

29. The method of claim 28, wherein forming a package frame comprises forming a metallic lead frame having package lead elements, a die paddle, and one or more antenna radiating elements.

30. The method of claim 29, wherein forming a metallic lead frame further comprises forming a metallic lead frame having an antenna feed structure.

31. The method of claim 29, wherein forming a metallic lead frame further comprises forming a recess region in one surface of the metallic lead frame which includes the one or more antenna radiating elements.

32. The method of claim 29, wherein mounting an IC chip comprises backside mounting the IC chip to the die paddle and forming bond wire connections from the IC chip to the one or more antenna elements and to package lead elements.

33. The method of claim 28, wherein forming a package cover comprises fully encapsulating the package frame and the IC chip within package cover material.

34. The method of claim 28, wherein forming a package cover comprises encapsulating a portion of the package frame to expose a region of the package frame in which the antenna is formed.
